(19) United States
(12) Patent Application Publication
(10) Pub. No.: US 2026/0216578 A1
(43) Pub. Date: Jul. 30, 2026

(54) METHOD FOR PREPARING SLIDING MAT, AND SLIDING MAT

(71) Applicant: SIMPLE GREEN CO., LTD., Huatan Township, Changhua County (TW)

(72) Inventors: ZHENYI GAO, Huatan Township, Changhua County (TW); YAJUAN ZHOU, Huatan Township, Changhua County (TW); SHANGJIE GAO, Huatan Township, Changhua County (TW); YUREN PAN, Huatan Township, Changhua County (TW); YONGHAN SHI, Huatan Township, Changhua County (TW)

(21) Appl. No.: 19/149,090

(22) PCT Filed: Jan. 17, 2023
(86) PCT No.: PCT/CN2023/072499

§ 371 Date: Jul. 17, 2025

(51) Int. Cl. A63B 69/00

(52) U.S. Cl. CPC A63B 69/00

(57) ABSTRACT

The present invention relates to the field of sports equipment, and in particular to a method for preparing a sliding mat, and a sliding mat. By means of structural optimization design, design components of various sliding mats and different combination and matching methods are provided. The surface of a prepared sliding mat has a planar structure having at least a sliding area, and having non-slip areas at least on two sides, which enables a user's sliding movement and slip prevention in an easier manner of use different from currently known sliding fitness equipment; moreover, the sliding mat prepared by the method of the present invention can be directly rolled up and stored in a more convenient manner of storage than known sliding boards among fitness equipment, thereby having high practical value.

### TECHNICAL FIELD

The present invention relates to the field of sports equipment, and more particularly to a method for preparing a sliding mat, and a sliding mat.

### BACKGROUND OF TECHNOLOGY

At present, numerous types of fitness equipment are available, such as weight training machines, treadmills, steppers, elliptical trainers, and rowing machines. These devices enable users to perform specific or combined training exercises for strengthening body muscles or enhancing cardiopulmonary function. Most professional-grade fitness equipment is generally large in size, structurally complex, and not easily disassembled or reassembled. As such, these devices are difficult to store in a dismantled state and are not suitable for use in households with limited interior space. Compact fitness equipment, although typically limited in functionality, occupies less space and is easier to store after use. Consumers may select suitable equipment according to their usage needs.

A sliding fitness apparatus disclosed in Taiwan Utility Model No. M427165 represents a compact type of fitness device. In this design, the user's feet are affixed to two sliding platforms mounted on a mat body, enabling lateral sliding motion. End barriers are respectively provided at both ends of the mat body to serve as stops for limiting the sliding range. Although the cited apparatus is convenient to use, it requires the user's feet to be fastened to the sliding platforms in order to operate. Additionally, the end barriers occupy a certain volume, and thus the apparatus still takes up space when stored after use.

### SUMMARY OF THE INVENTION

In view of the foregoing technical problems, it is necessary to provide a method for preparing a sliding mat and a sliding mat prepared by such method. The sliding mat enables the user to perform sliding movements and braking actions in a manner distinct from known sliding fitness devices, thereby offering a more convenient mode of use. In addition, the planar-type sliding mat can be directly rolled up for storage, providing enhanced convenience in storage.

The present invention discloses a method for manufacturing a sliding mat, comprising:
providing a woven sheet, the woven sheet comprising a sheet body having one side formed with a sliding area constituted by a plurality of pile fibers;
applying a liquid elastomer, the liquid elastomer being disposed on a peripheral region of the sheet body and at interfaces between the sheet body and the pile fibers;
curing and shaping, in which the liquid elastomer is cured and shaped through heating and/or vulcanization to obtain a shaped structure; and
forming non-slip regions, by disposing non-slip materials along at least two opposing sides of the woven sheet to define non-slip regions, thereby producing the sliding mat.

The present invention further discloses an alternative method for preparing a sliding mat, comprising:
providing a woven sheet, the woven sheet comprising a sheet body having, one side thereof, a sliding area constituted by a plurality of pile fibers;
applying a liquid elastomer, the liquid elastomer being disposed on a peripheral region of the sheet body and at interfaces between the sheet body and the pile fibers;
forming non-slip regions, by disposing non-slip materials along at least two opposing sides of the woven sheet to define non-slip regions; and
curing and shaping, in which the liquid elastomer is cured and shaped through heating and/or vulcanization to obtain a shaped structure, thereby producing the sliding mat.

In a preferred embodiment, in the step of applying the liquid elastomer, the woven sheet is immersed in the liquid elastomer with the pile fibers facing upward, such that the sheet body and the interfaces between the sheet body and the pile fibers are fully wetted.

In a preferred embodiment, in the step of applying the liquid elastomer, the woven sheet is immersed in the liquid elastomer with the pile fibers facing downward, such that the liquid elastomer is applied to the sheet body and its peripheral region, and penetrates the interfaces between the sheet body and the pile fibers.

In a preferred embodiment, between the step of applying the liquid elastomer and the step of curing and shaping, the method further comprises a step of attaching a non-slip sheet, wherein an uncured non-slip sheet is adhered to a side of the sheet body opposite to the pile fibers, such that after the curing and shaping step, the liquid elastomer and the non-slip sheet are integrally cured and bonded together.

In a preferred embodiment, the step of applying the liquid elastomer is combined with the step of forming non-slip regions as a single step, in which the liquid elastomer is first applied to a pre-formed non-slip sheet, and the woven sheet is then bonded thereto with the pile fibers facing upward. The non-slip sheet has a greater area than the woven sheet, with the portion of the non-slip sheet extending beyond the woven sheet to form the non-slip areas. After the curing and shaping step, the method further comprises a pressing step, in which the heated non-slip sheet, the liquid elastomer, and the woven sheet are subjected to pressure to compress them together, thereby bonding the non-slip sheet, the woven sheet, and the elastomer to one another.

The present invention further discloses a sliding mat prepared using the above-described preparation method, comprising:
a sliding area configured for a user to perform sliding movements thereon; and
a plurality of non-slip areas formed of non-slip material, and arranged in a planar configuration on at least two sides adjacent to the sliding area, configured to stop the user after sliding.

In a preferred embodiment, the sliding mat further comprises:
a woven sheet, one side of the woven sheet being provided with a plurality of pile fibers and the other side being bonded to a sheet-like elastomer, the pile fibers forming the sliding area; and
elastic sheets composed of a non-slip material and attached to opposite sides of the woven sheet to define the non-slip areas.

In a preferred embodiment, the sliding mat further comprises:
a ground-adhering sheet composed of a non-slip material; and
a sliding sheet composed of a low-friction material and adhered to a surface of the ground-adhering sheet, the sliding sheet being spaced from both ends of the ground-adhering sheet, thereby defining two non-slip areas between the sliding sheet and the respective ends of the ground-adhering sheet.

In a preferred embodiment, the sliding mat further comprises:
a ground-adhering sheet composed of a non-slip material, wherein the sliding area is formed by coating a lubricant on a predefined surface region on the ground-adhering sheet, and wherein surface portions on both sides that are not coated with the lubricant define the non-slip areas.

In a preferred embodiment, the sliding mat further comprises:
a ground-adhering sheet composed of a non-slip material; and
an elastic sheet adhered to a surface of the ground-adhering sheet, wherein the sliding area is formed by coating a lubricant on a predefined surface region of the elastic sheet, and wherein surface portions on both sides of the elastic sheet that are not coated with the lubricant define the non-slip areas.

In a preferred embodiment, the sliding mat further comprises:
a sliding sheet and two elastic sheets, wherein the sliding sheet is composed of a material having low surface friction, and the two elastic sheets are composed of a non-slip material and connected to opposite sides of the sliding sheet.

In a preferred embodiment, the sliding sheet and the elastic sheets have different colors, such that the connection boundary between the sliding sheet and the elastic sheets appears as a color-blended warning line.

In a preferred embodiment, the sliding mat further comprises a tensile sheet composed of a non-ductile material, disposed between the ground-adhering sheet and the sliding sheet described above; or between the sliding sheet and the elastic sheets described above.

In a preferred embodiment, each of the non-slip areas comprises a plurality of non-slip zones having different slip resistance levels, the non-slip zones being arranged along opposing sides of the sliding area, with the slip resistance progressively increasing with distance from the sliding area.

In a preferred embodiment, the sliding mat further comprises a covering film disposed on the surface of the sliding mat, the covering film being composed of a low-friction or non-slip material; when the covering film is composed of a low-friction material, the non-slip areas are formed by coating a non-slip agent, and wherein, when the film is composed of a non-slip material, the sliding area is formed by coating a lubricant.

In a preferred embodiment, the surface of the sliding area is further provided with a plurality of patterns configured to generate frictional heat during sliding of the user's feet.

In a preferred embodiment, the material of the sliding area is doped with a plurality of far-infrared radiation powders, thereby promoting the release of far-infrared radiation during frictional heating caused by foot sliding.

In a preferred embodiment, the material of the sliding area contains a plurality of thermochromic pigments configured to produce a color change in response to temperature variations during foot sliding.

In a preferred embodiment, the sliding mat further comprises a ground-adhering sheet composed of a non-slip material, wherein the sliding area is formed by adsorption of oil wax onto the ground-adhering sheet, and the areas on both sides of the sliding area that do not adsorb the oil wax define the non-slip areas.

By adopting the above technical solutions, the present invention achieves the following beneficial effects:

Through optimized structural design, the present invention proposes multiple sliding mat components and various combinatory configurations. The resulting sliding mat features a planar structure comprising at least one sliding area and non-slip areas disposed on at least two opposing sides. It enables users to perform sliding and braking movements in a manner distinct from existing sliding fitness devices, thereby simplifying operation. Moreover, the sliding mat can be directly rolled up for storage, which offers greater convenience compared to known sliding boards, and provides enhanced practical value.

### BRIEF DESCRIPTION OF THE DRAWINGS

In order to explicitly understand the content of the present invention much easily, the present invention is further illustrated in details based on the below embodiments in accompany with the attached drawings. The present invention is characterized as follows.

FIG. 1 is a flowchart illustrating the preparation method according to a first preferred embodiment of the present invention.

FIG. 2 is a schematic view showing the application of liquid elastomer in the preparation method of the first preferred embodiment of the present invention.

FIG. 3 is a schematic view of the sliding mat prepared using the method of the first preferred embodiment of the present invention.

FIG. 4 is a schematic view illustrating the usage of the sliding mat according to the first preferred embodiment of the present invention.

FIG. 5 is a schematic view of the preparation method according to a second preferred embodiment of the present invention.

FIG. 6 is a flowchart illustrating the preparation method according to a third preferred embodiment of the present invention.

FIG. 7 is a schematic view of the preparation method according to the third preferred embodiment of the present invention.

FIG. 8 is a flowchart illustrating the preparation method according to a fourth preferred embodiment of the present invention.

FIG. 9 is a schematic view of the preparation method according to the fourth preferred embodiment of the present invention.

FIG. 10 is a partial schematic view of the preparation method according to a fifth preferred embodiment of the present invention.

FIG. 11 is a partial schematic view of the preparation method according to a sixth preferred embodiment of the present invention.

FIG. 12 is a partial schematic view of the preparation method according to a seventh preferred embodiment of the present invention.

FIG. 13 is a schematic view of a sliding mat according to another preferred embodiment of the present invention.

FIG. 14 is a schematic view of a sliding mat according to a further preferred embodiment of the present invention.

FIG. 15 is a schematic view of a sliding mat according to yet another preferred embodiment of the present invention.

FIG. 16 is a schematic view of a sliding mat according to still another preferred embodiment of the present invention.

FIG. 17 is a schematic view of the non-slip area of the sliding mat according to the present invention.

### DETAILED DESCRIPTION OF THE PREFERRED EMBODIMENTS

To make the objectives, technical solutions, and advantages of the present invention more apparent, the following provides a detailed description in conjunction with the accompanying drawings and specific embodiments. It should be understood that the specific embodiments described herein are for illustrative purposes only and are not intended to limit the scope of the invention.

### Embodiment 1

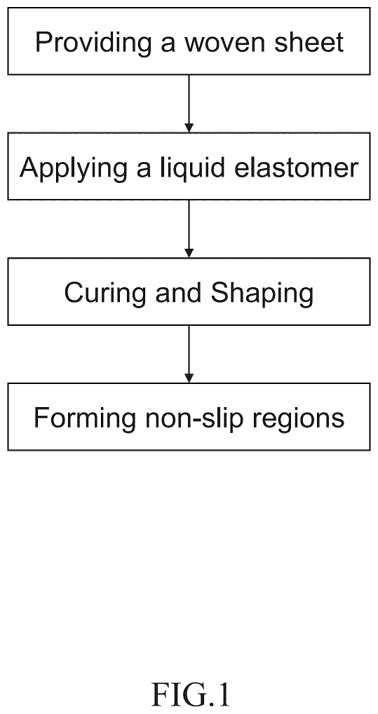

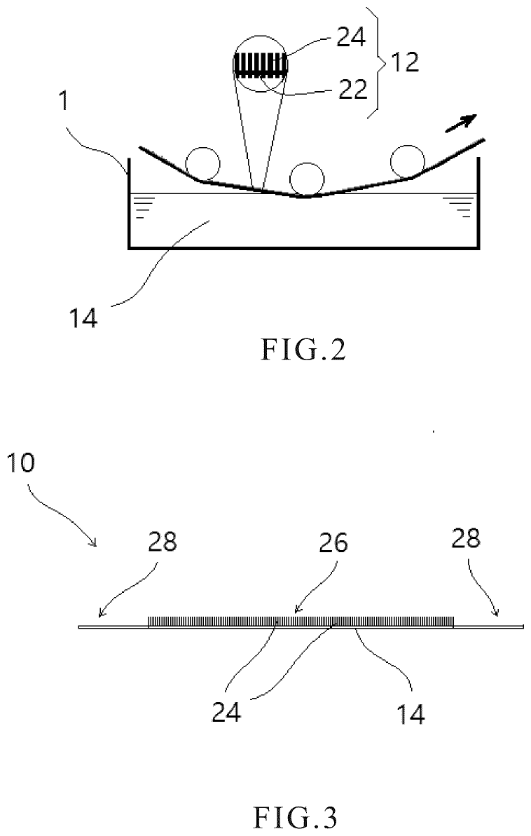

As shown in FIGS. 1 to 3, the present embodiment discloses a method for preparing a sliding mat.

The first step is providing a woven sheet: a woven sheet 12 is prepared in the form of a long strip and comprises a sheet body 22. The sheet body 22 may be made of non-woven fabric or a PP woven sheet, with no particular limitation. One side of the sheet body 22 is configured with a sliding area 26 formed by a plurality of pile fibers 24, each protruding from the sheet body 22 by brushing, electrostatic flocking, or weaving techniques.

The second step is applying a liquid elastomer: a liquid elastomer 14 is applied to the peripheral edges of the sheet body 22 and to the junctions between the sheet body 22 and each pile fiber 24. The liquid elastomer 14 may be selected from SBR, PU, EVA, natural rubber, hot melt adhesive, or other elastic materials, either in liquid form at room temperature or meltable upon heating, without particular limitation. The elastomer is first contained in a tank 1, and the woven sheet 12 is placed into the tank with the pile fibers 24 facing upward such that the sheet body 22 and the junctions with the pile fibers 24 are immersed. The liquid level is controlled so that only the roots of the pile fibers 24 are submerged in the liquid elastomer 14.

The third step is curing and shaping: the woven sheet 12 is subjected to known heating foaming or vulcanization techniques, such as a vulcanization foaming chamber or an oven 2, to cure and shape the liquid elastomer 14. When the elastomer is PU, vulcanization is performed; when the elastomer is EVA, foaming occurs.

The final step is forming non-slip areas: elastic sheets made of non-slip material, such as sheet-like natural rubber, are adhered to both longitudinal ends of the woven sheet 12 to form non-slip areas 28, thereby yielding a sliding mat 10.

Of course, in other configurations of the sliding mat 10, the non-slip areas 28 may be arranged around the entire periphery of the woven sheet 12 rather than only at both ends.

Furthermore, the elastic sheets may be attached to the side edges of the woven sheet 12 not only by adhesion, but also by stitching, or by fasteners such as zippers or buttons.

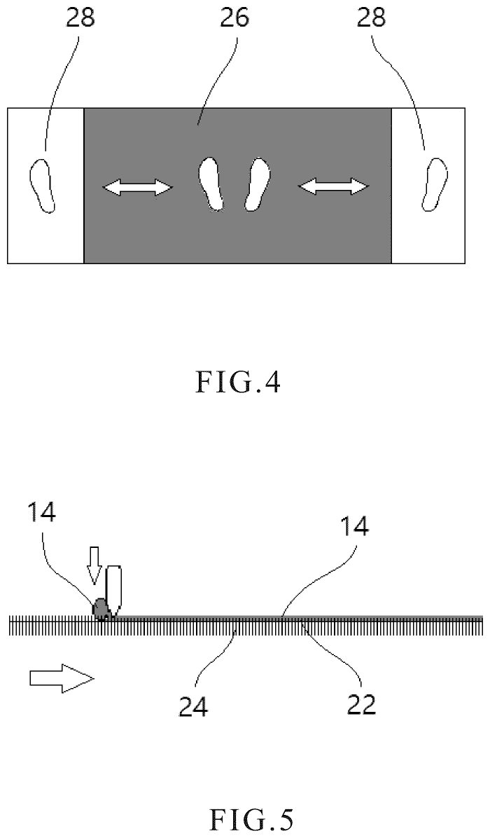

When the sliding mat 10 is laid flat on the ground, it remains stationary due to the anti-slip effect of the cured elastomer 14. The sliding area 26, comprising a plurality of upward-projecting pile fibers 24, exhibits reduced friction and enables the user to perform left-right or forward-backward sliding movements. Wearing socks further reduces friction. As shown in FIG. 4, the non-slip areas 28 allow the user to step thereon to stop after sliding through the sliding region 26. When not in use, the sliding mat 10 can be rolled up for convenient storage, which is an improvement over conventional sliding board.

### Embodiment 2

The present embodiment discloses a second preferred embodiment based on Embodiment 1. The main implementation method is based on Embodiment 1, wherein in the step of applying the liquid elastomer, as shown in FIG. 5, the woven sheet 12 is positioned with the pile fibers 24 facing downward, for example on a conveyor belt. The liquid elastomer 14 is coated onto the sheet body 22, covering its peripheral region and penetrating the interfaces between the sheet body 22 and the pile fibers 24.

### Embodiment 3

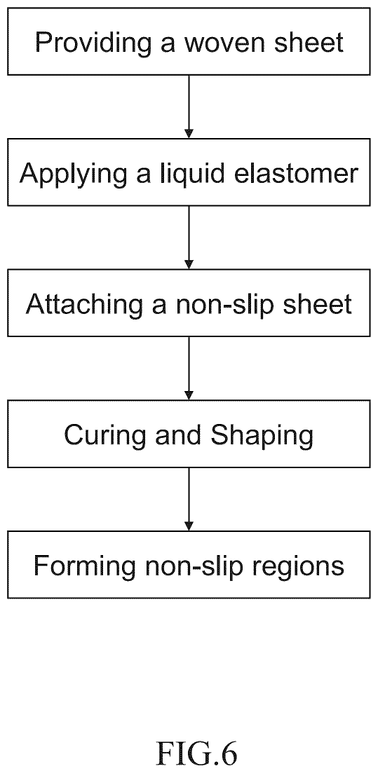

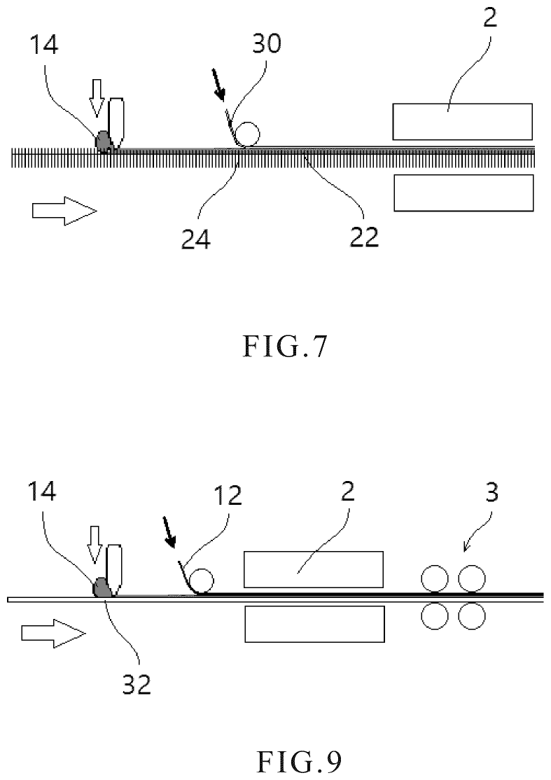

In continuation of Embodiment 1, this embodiment introduces a third preferred approach. While following the general preparation steps, the key difference is that, as shown in FIGS. 6 and 7, an additional step of attaching a non-slip sheet is included between the application of the liquid elastomer and its curing and shaping. Specifically, an uncured non-slip sheet 30, such as natural rubber sheet, is attached to the top side of the sheet body 22. After curing, the elastomer and the non-slip sheet 30 are integrally cured and shaped together.

### Embodiment 4

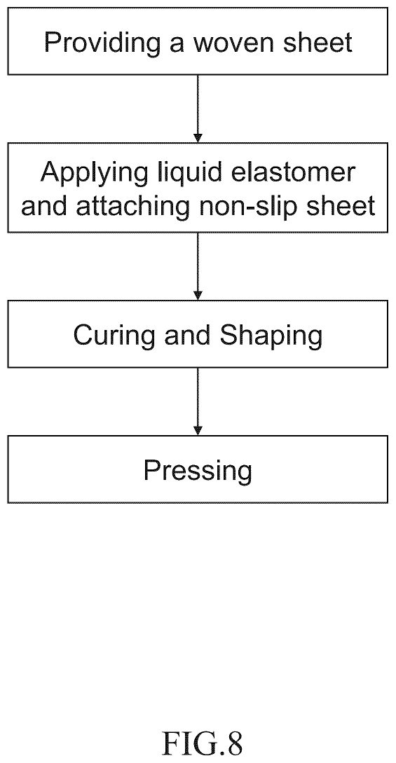

As illustrated in FIGS. 8 and 9, based on Embodiment 1, this embodiment combines the step of applying the liquid elastomer and forming the non-slip areas into a single integrated process. Specifically, the liquid elastomer 14 is first coated onto a pre-cured non-slip sheet 32, with a compatibilizer added to the elastomer to enhance polarity compatibility at the interface between the non-slip sheet 32 and the elastomer, thereby allowing the solid anti-slip sheet 32 to bond with the liquid elastomer 14. The woven sheet 12 is then bonded onto the non-slip sheet 32 with the pile fibers 24 facing upward. The area of the non-slip sheet 32 exceeds that of the woven sheet 12, so the protruding portion forms the non-slip areas 28. After curing, a pressing step is performed in which the heated non-slip sheet 32, the liquid elastomer 14, and the woven sheet 12 are pressed together using a roller press 3. Subsequent vulcanization finalizes the bond.

### Embodiment 5

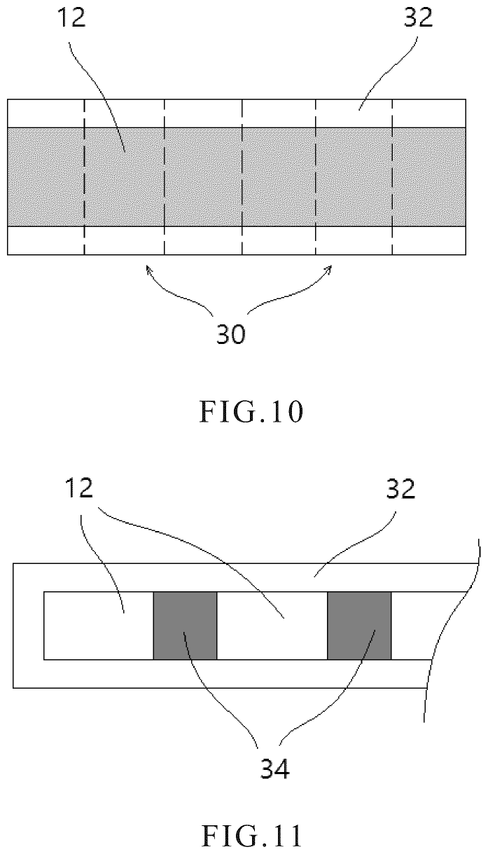

Based on Embodiment 4, this embodiment provides a fifth preferred implementation. The elongated non-slip sheet 32 is bonded to the woven sheet 12 using the aforementioned method. After bonding, the composite structure is cut into individual units to form sliding mats 10, as illustrated in FIG. 10.

### Embodiment 6

Building upon Embodiment 4, this embodiment presents a sixth preferred implementation. A plurality of release fabrics 34 (or release papers) are intermittently adhered to the elongated woven sheet 12. Following the curing and shaping process, the release fabrics 34 are peeled off, leaving behind untreated regions on the woven sheet 12 which serve as the non-slip areas 28. The bonded structure can then be cut to produce sliding mats 10 having non-slip areas 28 arranged along the entire periphery.

### Embodiment 7

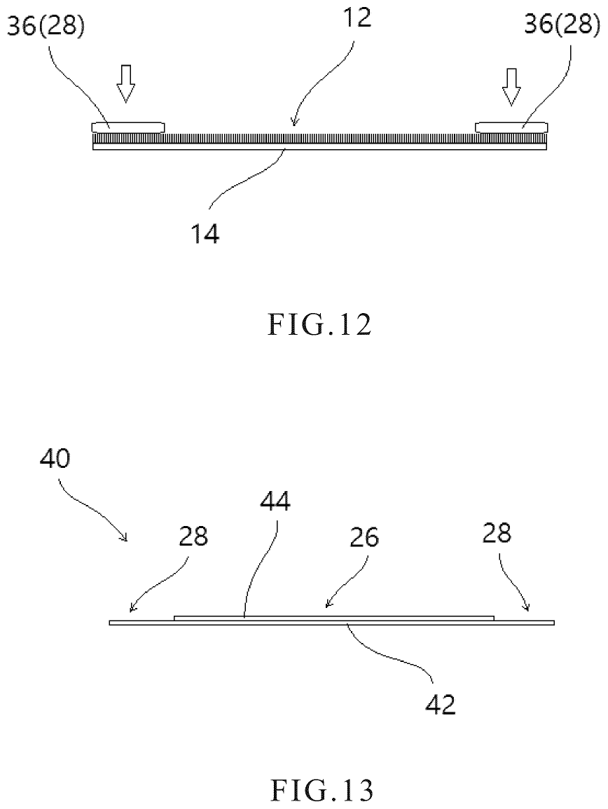

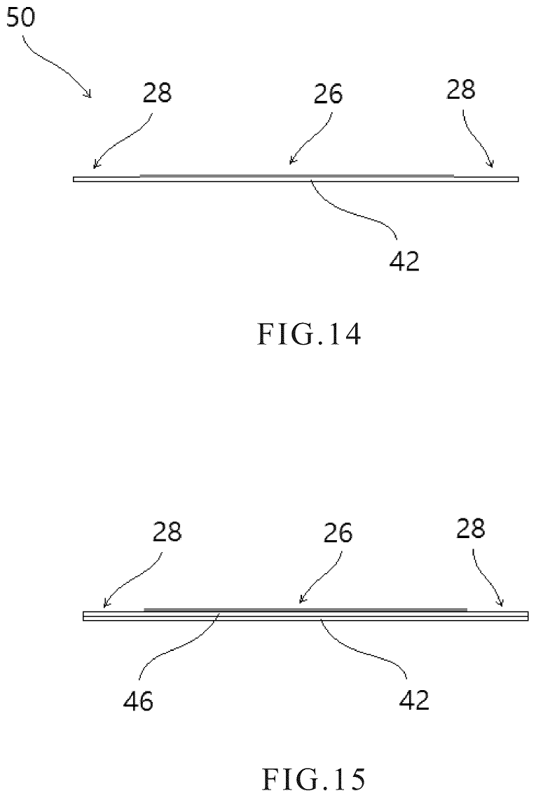

Derived from Embodiments 1 and 2, and as shown in FIG. 12, this embodiment provides an alternative method for forming the non-slip areas. Specifically, a non-slip material 4 is sprayed onto the pile fibers 24 located on opposite sides of the woven sheet 12 to form the non-slip areas 28. The non-slip material 4 may be a known anti-slip agent such as silicone, rubber, or plastic.

Additionally, the material composition and protrusion orientation of the pile fibers 24 may be further adjusted to fine-tune the sliding characteristics of the sliding mat 10. Such modifications may include varying the fiber material, applying additional coatings such as resin, or designing the fiber orientation (e.g., vertical or angled left/right via weaving). All such modifications fall within the scope of the present invention.

### Embodiment 8

This embodiment shares the basic structure of Embodiments 1 through 7. The sliding mat comprises a ground-adhering sheet 42 composed of a non-slip material (e.g., natural rubber), and a sliding sheet 44 composed of a low-friction material (e.g., PU, TPU, TPV, or TPE). The sliding area 26 is formed on the surface of the sliding sheet 44. The sliding sheet 44 is spaced apart from both ends of the ground-adhering sheet 42, such that the areas between the sliding sheet and the respective ends define two non-slip areas 28.

### Embodiment 9

Based on Embodiments 1-7, this embodiment omits the sliding sheet 44. Instead, the sliding area 26 is formed by applying a lubricant onto a surface of the ground-adhering sheet 42, while the uncoated sides serve as non-slip areas 28.

Alternatively, an elastic sheet 46 made of non-slip material may be adhered to the ground-adhering sheet 42, with lubricant coated onto its surface to form the sliding area 26. The uncoated portions then function as non-slip areas 28, as shown in FIG. 15.

Alternatively, the structure may include a sliding sheet 44 with elastic sheets 52 attached to both sides, replacing the need for the ground-adhering sheet 42.

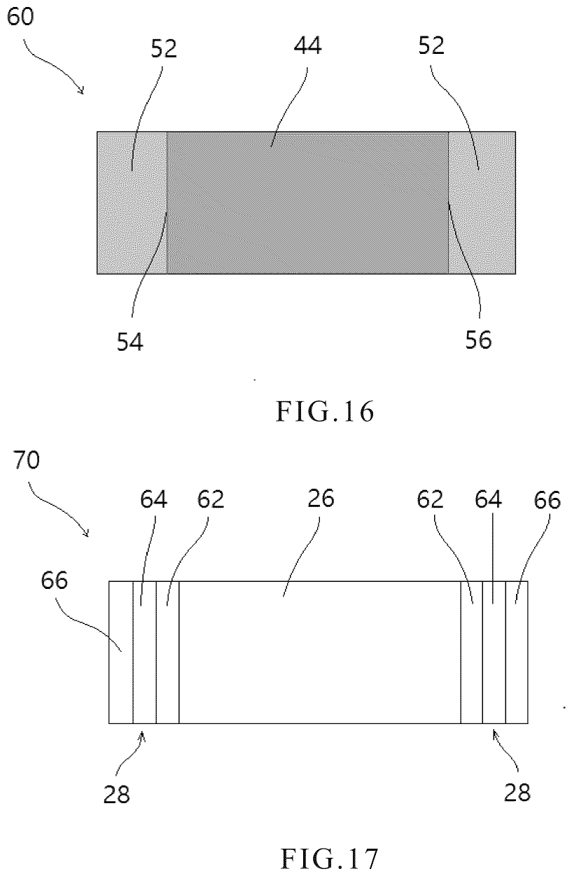

As shown in FIG. 16, the sliding sheet 44 and the elastic sheets 52 may have different colors, forming a two-tone warning line 54, 56 at their junction.

A tensile sheet (not shown), such as non-woven fabric, may also be inserted between the ground-adhering sheet 42 and sliding sheet 44 to enhance durability.

As shown in FIG. 17, the non-slip areas 28 of sliding mats 10, 40, 50, and 60 may include multiple non-slip zones 62, 64, 66 with progressively increasing slip resistance. For instance, zone 62 may offer 20%, zone 64 50%, and zone 66 100% slip resistance, achieving a progressive braking effect similar to an ABS system.

The sliding mats 40, 50, and 60 may also be equipped with a covering film (not shown), which may be made of low-friction material such as PP or PU, or a non-slip material such as natural rubber. If the covering film is low-friction, the non-slip areas are formed by applying a non-slip agent. If the film is non-slip, the sliding area is formed by applying a lubricant.

Additionally, the surface of the sliding area 26 may include patterns to generate heat through friction during foot movement, offering massage and warming effects. The sliding area 26 may also incorporate powders that emit far-infrared radiation (e.g., nano-carbon or graphene), further enhancing the health benefits of foot movement.

Thermochromic pigments may also be added to the sliding area 26 material to enable visual changes based on temperature, providing entertainment value and visual feedback for heat-based foot stimulation.

Optionally, the lubricant used in sliding mat 50 may be replaced with oil wax (e.g., silicone oil), wherein the sliding area 26 absorbs the oil wax and the uncoated sides form the non-slip areas 28. Barefoot sliding over such a surface may generate a hydraulic massage effect on the soles of the feet.

Although the above-described sliding mats are primarily designed for individual use, they may be enlarged—with non-slip areas at either two ends or around the entire perimeter—to accommodate multiple users, such as children engaging in sliding games, artistic sliding, or using the mat on inclined surfaces as an indoor slide or for activities simulating grass skiing or snow sports.

The above-described embodiments illustrate the objectives, technical solutions, and advantages of the present invention and are not intended to limit the scope thereof. Equivalent substitutions or improvements made within the spirit and principles of the invention shall fall within the scope of protection defined by the present application.

1-6. (canceled)

7: A sliding mat prepared by a method comprising:
providing a woven sheet, the woven sheet comprising a sheet body having one side formed with a sliding area constituted by a plurality of pile fibers;
applying a liquid elastomer, the liquid elastomer being disposed on a peripheral region of the sheet body and at interfaces between the sheet body and the pile fibers;
curing and shaping, in which the liquid elastomer is cured and shaped through heating and/or vulcanization to obtain a shaped structure; and
forming non-slip regions, by disposing non-slip materials along at least two opposing sides of the woven sheet to define non-slip regions, thereby producing the sliding mat;
wherein the sliding mat comprises:
a sliding area configured for a user to perform sliding movements thereon; and
a plurality of non-slip areas formed of non-slip material, and arranged in a planar configuration on at least two sides adjacent to the sliding area, configured to stop the user after sliding.

8. (canceled)

9: The sliding mat of claim 7, wherein the sliding mat further comprises:
a ground-adhering sheet composed of a non-slip material; and
a sliding sheet composed of a low-friction material and adhered to a surface of the ground-adhering sheet, the sliding sheet being spaced from both ends of the ground-adhering sheet, thereby defining two non-slip areas between the sliding sheet and the respective ends of the ground-adhering sheet.

10: The sliding mat of claim 7, wherein the sliding mat further comprises:
a ground-adhering sheet composed of a non-slip material, wherein the sliding area is formed by coating a lubricant on a predefined surface region on the ground-adhering sheet, and wherein surface portions on both sides that are not coated with the lubricant define the non-slip areas.

11: The sliding mat of claim 7, wherein the sliding mat further comprises:
a ground-adhering sheet composed of a non-slip material; and
an elastic sheet adhered to a surface of the ground-adhering sheet, wherein the sliding area is formed by coating a lubricant on a predefined surface region of the elastic sheet, and wherein surface portions on both sides of the elastic sheet that are not coated with the lubricant define the non-slip areas.

12: The sliding mat of claim 7, wherein the sliding mat further comprises:
a sliding sheet and two elastic sheets, wherein the sliding sheet is composed of a material having low surface friction, and the two elastic sheets are composed of a non-slip material and connected to opposite sides of the sliding sheet.

13: The sliding mat of claim 12, wherein the sliding sheet and the elastic sheets have different colors, such that the connection boundary between the sliding sheet and the elastic sheets appears as a color-blended warning line.

14: The sliding mat of claim 9, wherein the sliding mat further comprises a tensile sheet composed of a non-ductile material, disposed between the ground-adhering sheet and the sliding sheet;
or between the sliding sheet and elastic sheets.

15: The sliding mat of claim 7, wherein each of the non-slip areas comprises a plurality of non-slip zones having different slip resistance levels, the non-slip zones being arranged along opposing sides of the sliding area, with the slip resistance progressively increasing with distance from the sliding area.

16: The sliding mat of claim 7, wherein the sliding mat further comprises a covering film disposed on the surface of the sliding mat, the covering film being composed of a low-friction or non-slip material; wherein, when the covering film is composed of a low-friction material, the non-slip areas are formed by coating a non-slip agent, and wherein, when the film is composed of a non-slip material, the sliding area is formed by coating a lubricant.

17: The sliding mat of claim 7, wherein the surface of the sliding area is further provided with a plurality of patterns configured to generate frictional heat during sliding of the user's feet.

18: The sliding mat of claim 7, wherein the material of the sliding area is doped with a plurality of far-infrared radiation powders, thereby promoting the release of far-infrared radiation during frictional heating caused by foot sliding.

19: The sliding mat of claim 7, wherein the material of the sliding area contains a plurality of thermochromic pigments configured to produce a color change in response to temperature variations during foot sliding.

20: The sliding mat of claim 7, wherein the sliding mat further comprises a ground-adhering sheet composed of a non-slip material, wherein the sliding area is formed by adsorption of oil wax onto the ground-adhering sheet, and the areas on both sides of the sliding area that do not adsorb the oil wax define the non-slip areas.
